(19) United States
(12) Patent Application Publication
(10) Pub. No.: US 2007/0014572 A1
(43) Pub. Date: Jan. 18, 2007

(54) Bit error rate contour-based optimum decision threshold and sampling phase selection

(76) Inventors: Gilberto I. Sada, Irvine, CA (US); Keith Jones, Irvine, CA (US); Charles Chang, Coto de Caza, CA (US)

Correspondence Address: AKIN GUMP STRAUSS HAUER & FELD, LLP, P O BOX 688, DALLAS, TX, 75313-0688, US

(21) Appl. No.: 11/106,274

(22) Filed: Apr. 13, 2005

(51) Int. Cl. H04B 10/08

(52) U.S. Cl. 398/27

(57) ABSTRACT

A method and system for a bit error rate (BER) contour-based optimum decision threshold and sampling phase selection in optical communication systems is disclosed. According to one aspect of the invention, for a selected sampling phase and a decision threshold, high BER values are measured. Low BER values are approximated from the high BER values using error functions. The procedures are repeated for all selected sampling phases and decision thresholds and corresponding BER values are calculated. The sampling phases and decision thresholds for each specific BER value are plotted to create the BER contour diagrams. The optimum decision threshold for a sampling phase is calculated by equating the BER due to marks (“1s”) and the BER due to spaces (“0s”). In one aspect of the invention, a BER test module resides in the receiver. The BER test module calculates the BERs and the optimum decision threshold and sampling phase.

### RELATED APPLICATION

This application is related to an application entitled“METHOD AND SYSTEM FOR DETERMINING RECEIVER POWER FOR REQUIRED BIT ERROR RATE”, attorney docket number 185938/US, filed concurrently.

### TECHNICAL FIELD

The present invention relates generally to optical communication systems, and more specifically to a bit error rate (BER) contour-based optimum decision threshold and sampling phase selection in optical communication systems.

### BACKGROUND OF THE INVENTION

In optical communication systems, it is often desirable to determine an optimum decision threshold for a sampling phase while maintaining a specified BER.

The BER is a measure of a system's performance and reliability. FIG. 1 is a block diagram of an optical communication system 100. The system 100 includes a signal source 104 that generates a source signal Ss 105. The source signal Ss 105 is a digital signal having a binary data stream.

The signal Ss 105 is received by an optical transmitter 108 that converts the signal Ss 105 into an optical signal So 109. The signal So 109 is transmitted over a fiber channel 112 to an optical receiver 116. The optical receiver 116 converts the optical signal So 109 into an electrical signal Sr 117.

If Cₛ represents the number of bits in Sₛ and C_{RE} represents the number of error bits in S_{R}, then, BER can be represented by the following equation:

$$BER = \frac{{C}_{RE}}{{C}_{S}} \qquad ( 1 )$$

Where C_{RE} is defined as follows:

$${C}_{RE} = {\sum }_{n = 1}^{N} \vert {S}_{S} ( n ) - {S}_{R} ( n ) \vert . \qquad ( 2 )$$

And where S_{S}(n) represents the nth bit of the signal Ss and S_{R}(n) represents the nth bit of signal received by a BER tester 120 shown in FIG. 1.

The relationship of BER to sampling phases and decision thresholds is illustrated by a BER contour diagram. A BER contour diagram is created by measuring a plurality of BERs for various values of sampling phases and decision thresholds and plotting the points corresponding to a common BER.

A sampling phase indicates where in time an optical signal is sampled. For example, if an optical signal has a pulse width of 10 ns, the optical signal may be sampled at 0.1 ns, 1 ns or at any other time less than 10 ns, away from the origin of the pulse.

A decision threshold is a numerical value used to determine if the sampled bit is a mark (i.e., “1”) or a space (i.e., “0”). For example, if the decision threshold is 0.7, then sampled values greater than 0.7 are considered marks and sampled values less than 0.7 are considered spaces.

A plurality of BER contours are combined to create a BER contour diagram. FIG. 2 is a BER contour diagram that includes a plurality of BER contours.

Each contour in the diagram represents a specific BER value. In FIG. 2, the x-axis represents the sampling phase and the y-axis represents the decision threshold.

As discussed before, in many optical communication applications, it is desirable to determine an optimum decision threshold for a specific sampling phase while maintaining the BER within an acceptable value. In optical communication systems, signals degrade due to nonlinear effects such as chromatic dispersion, polarization mode dispersion, fiber characteristics and LASER characteristics. The nonlinear effects shift the optimum decision threshold for a sampling phase away from the mid point between the mark and the space in a nonlinear manner.

Since the optimum decision threshold cannot be calculated by linear methods, the optimum decision threshold needs to calculated using alternative procedures. Accordingly, there is a need for a method and system for determining an optimum decision threshold and sampling phase for a specified BER.

### SUMMARY OF THE INVENTION

The present invention is directed to a method and system for a bit error rate (BER) contour-based optimum decision threshold and sampling phase selection in optical communication systems. According to the invention, for a selected sampling phase and a decision threshold, high BER values are measured. The low BER values are approximated from the high BER values using error functions. The procedures are repeated for all selected sampling phases and decision thresholds and corresponding BER values are calculated. The BER contour diagram points are plotted for each specific sampling phase and decision threshold. The optimum decision threshold for a sampling phase is calculated by equating the BER corresponding to marks (“1s”) and the BER corresponding to spaces (“0s”). The optimum sampling phase is obtained from the BER contour by comparing the BERs of all sampling phases at their optimum decision thresholds. The sampling phase whose optimum decision threshold yields the lowest BER is selected as the optimum sampling phase. In one aspect of the invention, a BER test module resides in the receiver. The BER test module calculates the BERs and the optimum decision threshold.

### BRIEF DESCRIPTION OF THE DRAWINGS

FIG. 1 illustrates a block diagram of an optical communication system with a BER measurement module.

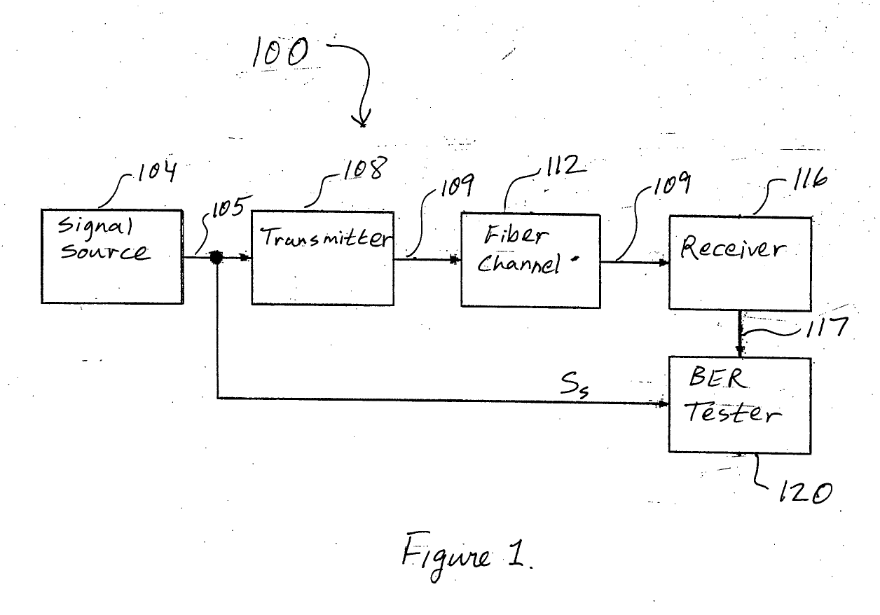

FIG. 2 is a BER contour diagram that includes a plurality of BER contours.

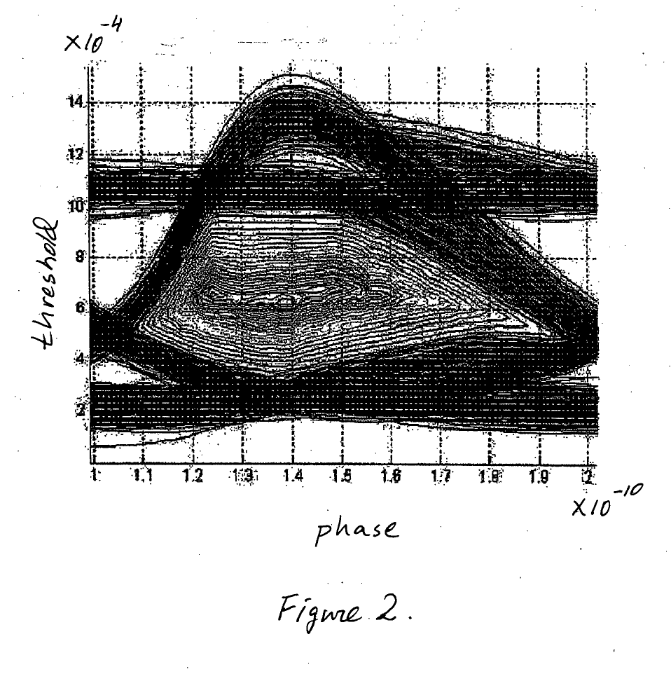

FIG. 3 is a flow diagram of the method steps involved in determining an optimum decision threshold for a sampling phase in accordance with one embodiment of the invention.

FIG. 4 illustrates a simplified block diagram of an optical communication system including a module to determine an optimum decision threshold in accordance with one embodiment of the invention.

### DETAILED DESCRIPTION OF PREFERRED EMBODIMENTS

In one embodiment of the invention, a BER contour diagram is created to locate the optimum threshold for a sampling phase. When BER values are high (e.g., >10e−5), they can be easily calculated. However, when BER values are low (e.g., <10e−8), it may require an unreasonably long time for the calculation. In one embodiment, high BER values are calculated for a selected sampling phase and decision threshold, and then low BER values are approximated from the high BER values to create a complete BER contour diagram.

When BER is relatively high, it is practical to measure BER at all sampling phases that a receiver can viably sample. A receiver may sample each pulse at one sampling phase at a time or may sample each pulse at a plurality of sampling phases at a time. The sampling phases may be distributed evenly across the pulse, or the sampling phases may be distributed in any other manner such as, for example, in a logarithmic distribution.

The BER measurements may be taken, for example, at decision thresholds close to the mark level (e.g., 0.8, 0.85, 0.9) and the space level (e.g., 0.1, 0.15, 0.2) at all selected sampling phases, because measurements close to mark and space levels will likely result in high BER.

When the decision threshold is set near an optimum level for detection, the BER can be low, and it may take an unreasonably long time to measure the BER. In order to complete the BER contour diagram where the BER is low, an equation provided below representing BER as a function of decision threshold for a particular sampling phase.

$$BER ( D ) = \frac{1}{2} \{ erfc ( \frac{\vert {μ}_{1} - D \vert}{{σ}_{1}} ) + erfc ( \frac{\vert {μ}_{0} - D \vert}{{σ}_{0}} ) \} \qquad ( 3 )$$

Where μ₁ and μ₀ represent the mean of the marks and spaces, respectively, D is the decision threshold, σ₁, and σ₀ represent standard deviation (the standard deviation represents the noise) of the mark and spaces respectively, and erfc is a complementary error function defined as follows:

$$ercf ( x ) = \frac{1}{\sqrt{2 π}} {\int }_{x}^{∞} {ⅇ}^{- \frac{{β}^{2}}{2}} ⅆ β \approx \frac{1}{x \sqrt{2 π}} {ⅇ}^{- \frac{{x}^{2}}{2}} \qquad ( 4 )$$

Equation (3) takes into consideration both the marks and spaces. However, where actual measurements are made for high BER, the decision level D is close to either the mark or the space level, and in those cases, equation (3) is simplified as follows:

$$BER ( D ) = \frac{1}{2} \{ erfc ( \frac{\vert {μ}_{0 , 1} - D \vert}{{σ}_{0 , 1}} ) \} \qquad ( 5 )$$

The logarithm base 10 of equation (5) yields:

$$\begin{matrix}{f ( log ( BER ( D ) ) )}^{- 1} = \frac{{μ}_{1} - D}{{σ}_{1}} \\ \approx 1.192 - 0.6681 ( log 10 ( BER ( D ) ) ) - \\ 0.0162 {( log 10 ( BER ( D ) ) )}^{2} for {μ}_{1} > D ( \text{?}\end{matrix}$$

$$\begin{matrix}{f ( log ( BER ( D ) ) )}^{- 1} = \frac{D - {μ}_{0}}{{σ}_{0}} \\ \approx 1.192 - 0.6681 ( log 10 ( BER ( D ) ) ) - \\ 0.0162 {( log 10 ( BER ( D ) ) )}^{2} for {μ}_{1} < D ( \text{?}\end{matrix}$$

$$\text{?} \text{indicates text missing or illegible when filed}$$

The parameters μ₁, μ₀, σ₁, and σ₀ are derived by using a polynomial fit in equations (6a) and (6b). Next, an approximation is used for marks from equation (6a) to obtain equation (7).

$$\frac{{μ}_{1} - D}{{σ}_{1}} = y . \qquad ( 7 )$$

Where y=1.192−0.6681(log10(BER(D)))−0.0162(log10(BER(D)))² (8)
The error term is minimized as follows:

$$E = {\sum }_{i = 0}^{n} {( \frac{{μ}_{1} - {D}_{i}}{{σ}_{1}} - {y}_{i} )}^{2} \qquad ( 9 )$$

Where yᵢ is obtained from equation (8) for each decision threshold Dᵢ where BER(Dᵢ) has been measured (BER is high at those decision thresholds). After further modifications, the equations (10) and (11) are obtained.

$$\begin{matrix}{σ}_{1} = \frac{\sum {D}_{i} \sum {D}_{i} - n \sum {D}_{i}^{2}}{n \sum {y}_{i} {D}_{i} - \sum {y}_{i} \sum {D}_{i}} & ( 10 ) \\ {μ}_{1} = \frac{{σ}_{1} ( \sum {D}_{i} \sum {D}_{i} {y}_{i} - \sum {y}_{i} \sum {D}_{i}^{2} )}{\sum {D}_{i} \sum {D}_{i} - n \sum {D}_{i}^{2}} & ( 11 )\end{matrix}$$

Similar equations can be derived for μ₀, and σ₀ where yᵢs and Dᵢs are calculated from the measurements obtained by decreasing the Dᵢs closer to the space level. Once the parameters μ₁, μ₀, σ₁ and σ₀ are obtained, BER(D) can be approximated using equation (3).

The foregoing procedures are repeated for all selected sampling phases and the decision thresholds and the BER values are calculated. The sampling phases and decision thresholds for each specific BER value are plotted to create the BER contour diagrams.

The optimum decision threshold for a sampling phase occurs when the BER due to the marks is equal to the BER due to the spaces. The BERs due to the marks and spaces are equal when equation (6a) is equal to equation (6b).

$$\begin{matrix}\frac{{μ}_{1} - D}{{σ}_{1}} = y = \frac{D - {μ}_{0}}{{σ}_{0}} & ( 12 ) \\ D = \frac{{σ}_{1} {μ}_{0} - {σ}_{0} {μ}_{1}}{{σ}_{1} - {σ}_{0}} & ( 13 )\end{matrix}$$

The optimum decision threshold and sampling phase is associated to the smallest BER(D) across all the BER contour.

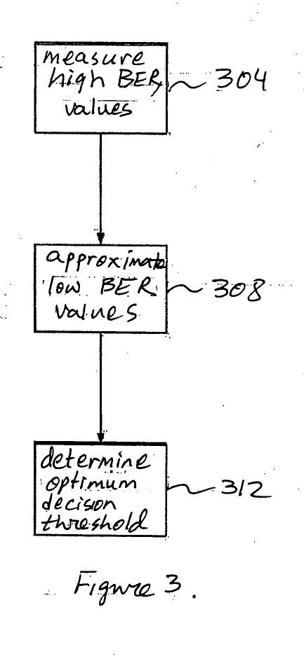

FIG. 3 is a flow diagram of the method steps involved in determining an optimum decision threshold for a sampling phase. In step 304, high BER values are measured. In step 308, low BER values are approximated using an error function. In step 312, an optimum decision threshold is calculated from BER due to marks and BER due to spaces.

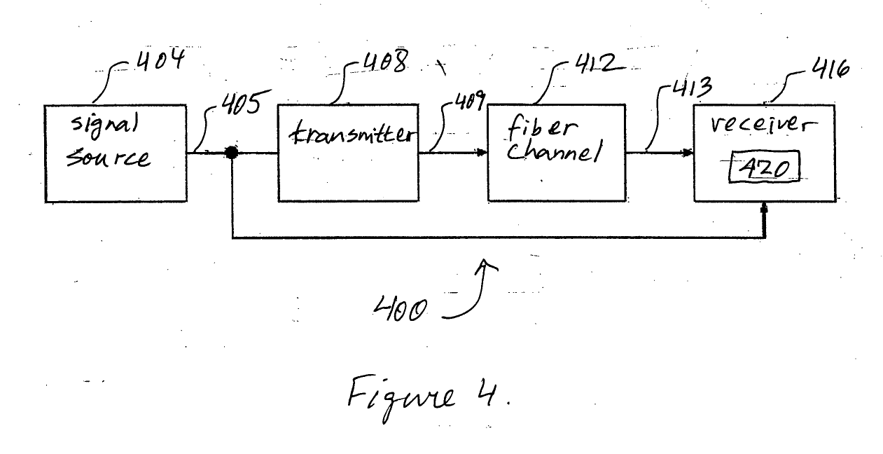

FIG. 4 illustrates a simplified block diagram of an optical communication system 400 including a module to determine an optimum decision threshold for a sampling phase. The system 400 includes a signal source 404 that generates a source signal 405. The signal 405 is received by an optical transmitter 408 and is converted into an optical signal 409. The transmitter 408 transmits the signal 409 over a fiber channel 412 to a receiver 416. The receiver 416 includes a module 420 that determines optimum decision thresholds for sampling phases using the foregoing steps. Although the module 420 is shown to reside inside the receiver 416, the module 420 may reside outside the receiver 416 or may reside in any other module in the system 400. The signal source 404 and the transmitter 408 can also reside inside a receiver system such as the receiver 416.

It is to be understood that even though various embodiments and advantages of the present invention have been set forth in the foregoing description, the above disclosure is illustrative only, and changes may be made in detail, and yet remain within the broad principles of the invention. For example, many of the components described above may be implemented using either digital or analog circuitry, or a combination of both, and also, where appropriate, may be realized through software executing on suitable processing circuitry.

What is claimed is:

1. A method for determining an optimum decision threshold in an optical communication system using a bit error rate (BER) contour, comprising:
transmitting a signal over a transmission medium;
receiving the signal;
measuring high BER values of the optical communication system using the transmitted and received signal, the BER values being measured using selected sampling phases and decision thresholds, the sampling phase indicating the sampling point in the signal and the decision threshold being a numerical value;
approximating low BER values from the high BER values;
creating the BER contour using the sampling phase and the decision threshold for each BER value; and
determining the optimum decision threshold from the BER corresponding to marks and the BER corresponding to spaces, the mark having a value equal to 1 and the space having a value equal to 0.

2. The method of claim 1 further comprising approximating the low BER values from the high BER values using error functions.

3. The method of claim 2 further comprising:
measuring the high BER values for all viable sampling phases; and
approximating the low BER values from the high BER values using error functions for all viable sampling phases.

4. The method of claim 2 further comprising determining the BER values corresponding to the marks and BER values corresponding to the spaces.

5. The method of claim 4 further comprising equating the BERs corresponding to the marks and BERs corresponding to the spaces to determine the optimum decision threshold.

6. The method of claim 5 further comprising calculating the optimum sampling phase and optimum decision threshold.

7. A system for determining an optimum decision threshold in an optical communication system using a bit error rate (BER) contour, comprising:
an optical transmitter coupled to a transmission medium and configured to transmit a signal over the transmission medium;
an optical receiver coupled to the transmission medium and configured to receive the signal;
means for measuring high BER values of the optical communication system;
means for approximating low BER values from the high BER values;
means for creating a BER contour; and
means for determining the optimum decision threshold and sampling phase using the BER contour.

8. The system of claim 7 wherein the high BER values are measured using the transmitted and received signal, the BER values being measured using selected sampling phases and decision thresholds.

9. The system of claim 8 wherein the sampling phase indicates the sampling point in the received signal and the decision threshold is a numerical value.

10. The system of claim 7 further comprising means for creating the BER contour using the sampling phase and the decision threshold for each BER value.

11. The system of claim 7 further comprising means for approximating the low BER values from the high BER values using error functions.

12. The system of claim 11 further comprising:
means for measuring the high BER values for all viable sampling phases; and
means for approximating the low BER values from the high BER values using error functions for all viable sampling phases.

13. The system of claim 11 further comprising means for determining the BERs corresponding to the marks and BERs corresponding to the spaces.
